(19) United States
(12) Patent Application Publication
(10) Pub. No.: US 2023/0291222 A1
(43) Pub. Date: Sep. 14, 2023

(54) POWER MANAGEMENT DEVICE, POWER FEEDING SYSTEM AND POWER MANAGEMENT METHOD

(71) Applicant: TDK Corporation, Tokyo (JP)

(72) Inventors: Takuma MITSUNAGA, Tokyo (JP); Shingo SUZUKI, Tokyo (JP); Katsuo NAOI, Tokyo (JP); Masao ICHI, Tokyo (JP); Hisakazu UTO, Tokyo (JP)

(73) Assignee: TDK Corporation, Tokyo (JP)

(21) Appl. No.: 17/967,648

(22) Filed: Oct. 17, 2022

(30) Foreign Application Priority Data
Mar. 9, 2022 (JP) 2022-036162

(51) Int. Cl. H02J 7/00; H02J 7/34; H02M 1/00

(52) U.S. Cl. CPC H02J 7/00712; H02J 7/34; H02J 7/0048; H02M 1/008; H02J 2207/20

(57) ABSTRACT

A power management device includes a control unit that switches an operation mode of a power feeding system by controlling a converter capable of bidirectionally converting between an internal bus voltage and an external bus voltage. The control unit sets the power feeding system to a power reception mode by setting a target value of the external bus voltage in the converter to a first target value when the amount of stored electric power is less than a first storage threshold value. The control unit sets the power feeding system to a power transmission mode by setting the target value to a second target value that is larger than the first target value when the amount of stored electric power exceeds a second storage threshold value that is larger than the first storage threshold value and a measured value of the external bus voltage exceeds a transmission threshold value.

### CROSS-REFERENCE TO RELATED APPLICATION

This application is based on Japanese Patent Application No. 2022-036162 filed with Japan Patent Office on Mar. 9, 2022 and claims the benefit of priority thereto. The entire contents of the application are incorporated herein by reference.

### TECHNICAL FIELD

The present disclosure relates to a power management device, a power feeding system and a power management method.

### BACKGROUND

There is known a power interchange system for mutually transmitting and receiving electric power between a power transmission/reception unit (power feeding system) and another power transmission/reception unit. For example, Japanese Unexamined Patent Application Publication No. 2015-177686 describes a power interchange system in which one or more power transmission/reception units (power feeding systems) and a virtual power transmission network construction device are connected via a communication network. The power transmission/reception unit expresses participation in a demand area system to the virtual power transmission network construction device via the communication network. The virtual power transmission network construction device performs power interchange between power transmission/reception units by giving necessary instructions (power transmission paths and power transmission timings) to a power transmission/reception control unit (power management device) of the power transmission/reception unit that has expressed participation in the demand area system.

### SUMMARY

In the power interchange system described in Japanese Unexamined Patent Application Publication No. 2015-177686, all power transmission/reception units of one demand area system must be able to connect to the same virtual power transmission network construction device via the communication network. However, when the power system is stopped due to a natural disaster or the like, there is a possibility that the communication network is disconnected. In such a case, since the connection between the power transmission/reception unit and the virtual power transmission network construction device is cut off, there is a possibility that power transmission/reception cannot be performed.

The present disclosure describes a power management device, a power feeding system, and a power management method that can perform power transmission and reception without using any communication network.

A power management device according to one aspect of the present disclosure includes: a first acquisition unit that acquires an amount of stored electric power of a power feeding system connected to another power feeding system via an external direct current (DC) bus; a second acquisition unit that acquires a measured value of an external bus voltage supplied to the external DC bus; and a control unit that switches an operation mode of the power feeding system by controlling a converter provided between the external DC bus and an internal DC bus for supplying DC electric power in the power feeding system, the converter being capable of bidirectionally converting between the external bus voltage and an internal bus voltage supplied to the internal DC bus. The control unit sets the power feeding system to a power reception mode by setting a target value of the external bus voltage in the converter to a first target value when the amount of stored electric power is less than a first storage threshold value, and the control unit sets the power feeding system to a power transmission mode by setting the target value to a second target value that is larger than the first target value when the amount of stored electric power exceeds a second storage threshold value that is larger than the first storage threshold value and the measured value exceeds a transmission threshold value.

In this power management device, the operation mode of the power feeding system is switched based on the amount of stored electric power of the power feeding system. When the amount of stored electric power of the power feeding system is less than the first storage threshold value, the target value of the external bus voltage in the converter of the power feeding system is set to the first target value, and the power feeding system is set to the power reception mode. At this time, on the assumption that similar control is performed in another power feeding system and that another power feeding system is set to the power transmission mode, the target value of the external bus voltage in a converter of another power feeding system is set to the second target value. Since the second target value is larger than the first target value, a potential difference is generated in the external DC bus, and electric power is supplied from another power feeding system set to the power transmission mode toward the power feeding system set to the power reception mode. Similarly, on the assumption that another power feeding system is set to the power reception mode, the target value of the external bus voltage in the converter of another power feeding system is set to the first target value. Therefore, since the measured value of the external bus voltage exceeds the transmission threshold value, when the amount of stored electric power of the power feeding system exceeds the second storage threshold value, the target value of the external bus voltage in the converter of the power feeding system is set to the second target value, and the power feeding system is set to the power transmission mode. Also, in this case, a potential difference is generated in the external DC bus, and electric power is supplied from the power feeding system set to the power transmission mode toward another power feeding system set to the power reception mode. According to this configuration, it is not necessary for the power feeding system to transmit a power reception request or the like via a communication network. Therefore, electric power can be transmitted and received without using any communication network.

In some embodiments, the control unit may reset the power reception mode in response to the amount of stored electric power exceeding a third storage threshold value that is smaller than the second storage threshold value and larger than the first storage threshold value when the power feeding system is set to the power reception mode. According to this configuration, the power reception mode can be reset before the power feeding system receives excessive electric power. This makes it possible to receive electric power from another power feeding system to the extent that the power feeding system does not receive electric power more than necessary.

In some embodiments, the control unit may reset the power transmission mode in response to the amount of stored electric power becoming less than a fourth storage threshold value that is smaller than the second storage threshold value and larger than the first storage threshold value when the power feeding system is set to the power transmission mode. According to this configuration, the power transmission mode can be reset before the amount of stored electric power of the power feeding system becomes insufficient. This makes it possible to transmit electric power to another power feeding system to the extent that the stored electric power of the power feeding system is not insufficient.

In some embodiments, the control unit may reset the power transmission mode in response to detecting that no electric power is supplied to the external DC bus via the converter when the power feeding system is set to the power transmission mode. When no electric power is supplied to the external DC bus via the converter, it is considered that another power feeding system has reset the power reception mode. In this case, it is not necessary for the power feeding system to transmit electric power to another power feeding system. According to the configuration described above, when another power feeding system resets the power reception mode, the power feeding system can reset the power transmission mode.

A power feeding system according to another aspect of the present disclosure is a system that supplies electric power bidirectionally with respect to another power feeding system via an external direct current (DC) bus. This power feeding system includes: an internal DC bus for supplying DC electric power; a first converter provided between a power supply device and the internal DC bus, the first converter that converts a voltage generated by the power supply device into an internal bus voltage supplied to the internal DC bus; a second converter connected to the internal DC bus, the second converter that converts the internal bus voltage into a load voltage supplied to a load device; a storage battery; a third converter provided between the storage battery and the internal DC bus, the third converter being capable of bidirectionally converting between the internal bus voltage and a battery voltage of the storage battery; a fourth converter provided between the internal DC bus and the external DC bus, the fourth converter being capable of bidirectionally converting between the internal bus voltage and an external bus voltage supplied to the external DC bus; and a power management device that charges and discharges the storage battery by controlling the third converter, and that switches an operation mode of the power feeding system by controlling the fourth converter. The power management device sets the power feeding system to a power reception mode by setting a target value of the external bus voltage in the fourth converter to a first target value when an amount of stored electric power of the storage battery is less than a first storage threshold value. The power management device sets the power feeding system to a power transmission mode by setting the target value to a second target value that is larger than the first target value when the amount of stored electric power exceeds a second storage threshold value that is larger than the first storage threshold value and a measured value of the external bus voltage exceeds a transmission threshold value.

In this power feeding system, the operation mode of the power feeding system is switched based on the amount of stored electric power of the storage battery. When the amount of stored electric power of the storage battery is less than the first storage threshold value, the target value of the external bus voltage in the fourth converter of the power feeding system is set to the first target value, and the power feeding system is set to the power reception mode. At this time, on the assumption that similar control is performed in another power feeding system and that another power feeding system is set to the power transmission mode, the target value of the external bus voltage in a fourth converter of another power feeding system is set to the second target value. Since the second target value is larger than the first target value, a potential difference is generated in the external DC bus, and electric power is supplied from another power feeding system set to the power transmission mode toward the power feeding system set to the power reception mode. Similarly, on the assumption that another power feeding system is set to the power reception mode, the target value of the external bus voltage in the fourth converter of another power feeding system is set to the first target value. Therefore, since the measured value of the external bus voltage exceeds the transmission threshold value, when the amount of stored electric power of the storage battery exceeds the second storage threshold value, the target value of the external bus voltage in the fourth converter of the power feeding system is set to the second target value, and the power feeding system is set to the power transmission mode. Also, in this case, a potential difference is generated in the external DC bus, and electric power is supplied from the power feeding system set to the power transmission mode toward another power feeding system set to the power reception mode. According to this configuration, it is not necessary for the power feeding system to transmit a power reception request or the like via a communication network. Therefore, electric power can be transmitted and received without using any communication network.

A power management method according to yet another aspect of the present disclosure includes: acquiring an amount of stored electric power of a power feeding system connected to another power feeding system via an external direct current (DC) bus; acquiring a measured value of an external bus voltage supplied to the external DC bus; setting the power feeding system to a power reception mode by setting a target value of the external bus voltage in a converter provided between the external DC bus and an internal DC bus for supplying DC electric power in the power feeding system to a first target value when the amount of stored electric power is less than a first storage threshold value, the converter being capable of bidirectionally converting between the external bus voltage and an internal bus voltage supplied to the internal DC bus; and setting the power feeding system to a power transmission mode by setting the target value to a second target value that is larger than the first target value when the amount of stored electric power exceeds a second storage threshold value that is larger than the first storage threshold value and the measured value exceeds a transmission threshold value.

In this power management method, the operation mode of the power feeding system is switched based on the amount of stored electric power of the power feeding system. When the amount of stored electric power of the power feeding system is less than the first storage threshold value, the target value of the external bus voltage in the converter of the power feeding system is set to the first target value, and the power feeding system is set to the power reception mode. At this time, on the assumption that similar control is performed in another power feeding system and that another power feeding system is set to the power transmission mode, the target value of the external bus voltage in a converter of another power feeding system is set to the second target value. Since the second target value is larger than the first target value, a potential difference is generated in the external DC bus, and electric power is supplied from another power feeding system set to the power transmission mode toward the power feeding system set to the power reception mode. Similarly, on the assumption that another power feeding system is set to the power reception mode, the target value of the external bus voltage in the converter of another power feeding system is set to the first target value. Therefore, since the measured value of the external bus voltage exceeds the transmission threshold value, when the amount of stored electric power of the power feeding system exceeds the second storage threshold value, the target value of the external bus voltage in the converter of the power feeding system is set to the second target value, and the power feeding system is set to the power transmission mode. Also, in this case, a potential difference is generated in the external DC bus, and electric power is supplied from the power feeding system set to the power transmission mode toward another power feeding system set to the power reception mode. According to this configuration, it is not necessary for the power feeding system to transmit a power reception request or the like via a communication network. Therefore, electric power can be transmitted and received without using any communication network.

According to each aspect and each embodiment of the present disclosure, electric power can be transmitted and received without using any communication network.

### BRIEF DESCRIPTION OF THE DRAWINGS

FIG. 1 is a configuration diagram schematically showing a power interchange system including a power feeding system according to an embodiment.

FIG. 2 is a configuration diagram schematically showing the power feeding system shown in FIG. 1.

FIG. 3 is a hardware configuration diagram of the power management device shown in FIG. 2.

FIG. 4 is a functional block diagram of the power management device shown in FIG. 2.

FIG. 5 is a flowchart showing a series of processes of a power management method performed by the power management device shown in FIG. 2.

FIG. 6 is a flowchart showing the power reception process shown in FIG. 5 in detail.

FIG. 7 is a flowchart showing the power transmission process shown in FIG. 5 in detail.

FIG. 8 is a diagram for explaining power transmission and reception between the power feeding systems shown in FIG. 1.

### DETAILED DESCRIPTION

In the following, some embodiments of the present disclosure will be described with reference to the drawings. It should be noted that in the description of the drawings, the same components are designated with the same reference signs, and the redundant description is omitted.

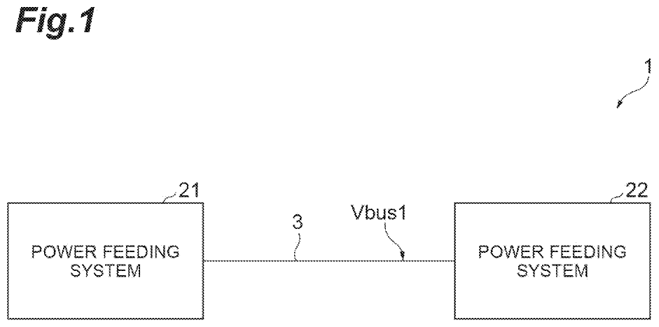

FIG. 1 is a configuration diagram schematically showing a power interchange system including a power feeding system according to an embodiment. A power interchange system 1 shown in FIG. 1 is a system for supplying direct current (DC) electric power bidirectionally with respect to each other among a plurality of power feeding systems. Hereinafter, supplying DC electric power is referred to as “power transmission”, receiving DC electric power is referred to as “power reception”, and these are collectively referred to as “power transmission and reception”. The power interchange system 1 includes the plurality of power feeding systems and an external DC bus 3. In the present embodiment, a configuration in which the power interchange system 1 includes two power feeding systems (a power feeding system 21 and a power feeding system 22 (another power feeding system)) is illustrated. The power feeding system 21 and the power feeding system 22 are connected to each other via the external DC bus 3. In this case, one of the power feeding system 21 and the power feeding system 22 supplies electric power to the other. For example, when the amount of electric power stored in the power feeding system 21 (the amount of stored electric power will be described later) is excessive and the amount of electric power stored in the power feeding system 22 is insufficient, the power feeding system 21 supplies electric power to the power feeding system 22 via the external DC bus 3.

The external DC bus 3 is a bus that functions as a bus line for supplying DC electric power between the power feeding system 21 and the power feeding system 22. An external bus voltage Vbus1 is supplied to the external DC bus 3. The external bus voltage Vbus1 is a high DC voltage. The external bus voltage Vbus1 is, for example, a voltage of DC 350 V or more and DC 410 V or less. The voltage value of the external bus voltage Vbus1 is set by the power feeding system 21 or the power feeding system 22.

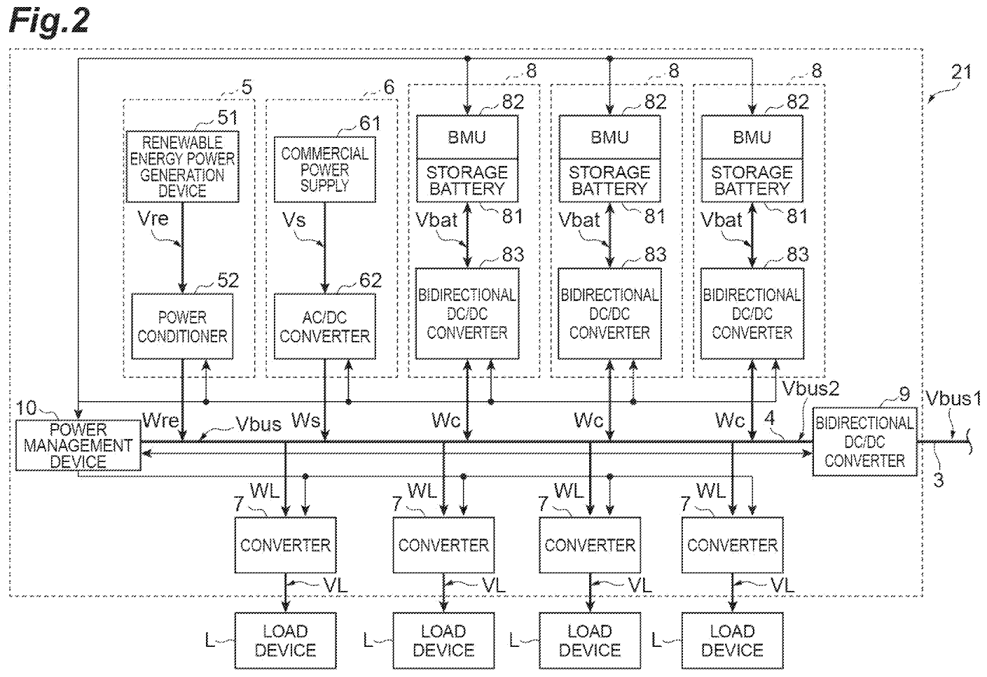

FIG. 2 is a configuration diagram schematically showing the power feeding system shown in FIG. 1. Since the power feeding system 22 has the configuration similar to that of the power feeding system 21, only the power feeding system 21 will be described here. As shown in FIG. 2, the power feeding system 21 is a system that supplies load power WL (load voltage VL) to load devices L. In the present embodiment, the power feeding system 21 is a DC power feeding system. The load device L may be a DC load device that operates with a DC voltage or an alternating current (AC) load device that operates with an AC voltage. Examples of DC load devices include a light emission diode (LED) illuminators, DC fans, televisions, and personal computers. Examples of AC load devices include washing machines, refrigerators, and air conditioners. The power feeding system 21 and the power feeding system 22 supply electric power to each other via the external DC bus 3.

The power feeding system 21 includes an internal DC bus 4, a power supply device 5, an auxiliary power supply device 6, converters 7 (second converters), power storage devices 8, a bidirectional DC/DC converter 9 (fourth converter), and a power management device 10.

The internal DC bus 4 is a bus that functions as a bus line for performing DC power supply for supplying DC electric power within the power feeding system 21. The internal DC bus 4 is laid across the installation locations of the power supply device 5, the auxiliary power supply device 6, the converters 7, and the power storage devices 8. An internal bus voltage Vbus2 is supplied to the internal DC bus 4. The internal bus voltage Vbus2 is a high DC voltage. The internal bus voltage Vbus2 is set to be included in the range of the input voltage of the converter 7. The internal bus voltage Vbus2 is, for example, a voltage equal to or higher than DC 240 V and equal to or lower than DC 300 V. The value of the internal bus voltage Vbus2 may be fixed or variable. It should be noted that the values of the external bus voltage Vbus1 and the internal bus voltage Vbus2 are not limited to those described above. The value of the external bus voltage Vbus1 may be the same as the value of the internal bus voltage Vbus2, or the value of the internal bus voltage Vbus2 may be larger than the value of the external bus voltage Vbus1.

The power supply device 5 is a device that supplies electric power to the internal DC bus 4. In the present embodiment, the power feeding system 21 includes one power supply device 5. The number of power supply devices 5 is not limited to one, and may be appropriately changed as necessary. The power supply device 5 includes a renewable energy power generation device 51 and a power conditioner 52 (first converter).

The renewable energy power generation device 51 is a device that generates generated power Wre. Examples of the renewable energy power generation device 51 include a photovoltaic power generation device, a wind power generation device, a hydroelectric power generation device, and a geothermal power generation device. The renewable energy power generation device 51 is connected to the internal DC bus 4 via the power conditioner 52. The renewable energy power generation device 51 generates a power generation voltage Vre having a predetermined voltage value, and outputs the generated power Wre corresponding to the power generation voltage Vre. The power generation voltage Vre may be a DC voltage or an AC voltage.

The power conditioner 52 is connected to the internal DC bus 4, and is a device that converts the power generation voltage Vre into the internal bus voltage Vbus2. The power conditioner 52 is provided between the renewable energy power generation device 51 and the internal DC bus 4. When the power generation voltage Vre is a DC voltage, the power conditioner 52 includes a DC/DC converter. When the power generation voltage Vre is an AC voltage, the power conditioner 52 includes an AC/DC converter. The power conditioner 52 operates with, for example, a DC voltage internally generated based on the internal bus voltage Vbus2. The power conditioner 52 controls the generated power Wre by controlling the power generation operation of the renewable energy power generation device 51 based on a command from the power management device 10.

When the power conditioner 52 receives a start command from the power management device 10, the power conditioner 52 converts the power generation voltage Vre into the internal bus voltage Vbus2 and supplies the internal bus voltage Vbus2 to the internal DC bus 4, thereby supplying the generated power Wre to the internal DC bus 4. When the power conditioner 52 receives a stop command from the power management device 10, the power conditioner 52 stops supplying the generated power Wre.

The power conditioner 52 has a power measurement function of measuring the generated power Wre supplied from the renewable energy power generation device 51 to the internal DC bus 4. The power conditioner 52 periodically measures the generated power Wre, for example. The power conditioner 52 transmits the measured value of the generated power Wre to the power management device 10.

The auxiliary power supply device 6 is a device that supplies electric power to the internal DC bus 4. The auxiliary power supply device 6 includes a commercial power supply 61 and an AC/DC converter 62. The commercial power supply 61 supplies system power Ws including a system voltage Vs having a predetermined voltage value. The system voltage Vs is an AC voltage. The commercial power supply 61 is connected to the internal DC bus 4 via the AC/DC converter 62.

The AC/DC converter 62 is connected to the internal DC bus 4, and is a device that converts the system voltage Vs into the internal bus voltage Vbus2. The AC/DC converter 62 is provided between the commercial power supply 61 and the internal DC bus 4. The AC/DC converter 62 operates with, for example, a DC voltage internally generated based on the system voltage Vs. When the AC/DC converter 62 receives a start command from the power management device 10, the AC/DC converter 62 converts the system voltage Vs into the internal bus voltage Vbus2 and supplies the internal bus voltage Vbus2 to the internal DC bus 4, thereby supplying the system power Ws to the internal DC bus 4. When the AC/DC converter 62 receives a stop command from the power management device 10, the AC/DC converter 62 stops supplying the system power Ws. The AC/DC converter 62 has a power measurement function of measuring the system power Ws supplied from the commercial power supply 61 to the internal DC bus 4. The AC/DC converter 62 periodically measures the system power Ws, for example. The AC/DC converter 62 transmits the measured value of the system power Ws to the power management device 10.

Since the auxiliary power supply device 6 can stably supply electric power, the auxiliary power supply device 6 is controlled so as to supply electric power when the electric power of the entire power feeding system 21 is insufficient. In order to maintain the power feeding system 21, the system power Ws is equal to or larger than the sum of the total load power WL and the standby power in the power feeding system 21. The standby power includes power consumption of the power management device 10 and power consumption of auxiliary devices (relays, fans, and small-capacity power supplies, not shown).

The converter 7 is connected to the internal DC bus 4, and is a device that converts the internal bus voltage Vbus2 into a load voltage VL. The load voltage VL is a voltage supplied to the load device L. The load device L is connected to the internal DC bus 4 via the converter 7. The converter 7 operates with, for example, a DC voltage internally generated based on the internal bus voltage Vbus2. In the present embodiment, the power feeding system 21 includes four converters 7. The number of converters 7 is not limited to four, and may be changed in accordance with the number of load devices L.

When the converter 7 receives a start command from the power management device 10, the converter 7 converts the internal bus voltage Vbus2 into the load voltage VL, and supplies the load voltage VL (load power WL) to the load device L. When the load device L is a DC load device, the load voltage VL is a DC voltage, and the converter 7 is a DC/DC converter. For example, the converter 7 converts the internal bus voltage Vbus2 of DC 270 V into the load voltage VL of DC 24 V. When the load device L is an AC load device, the load voltage VL is an AC voltage, and the converter 7 is a DC/AC converter. When the converter 7 receives a stop command from the power management device 10, the converter 7 stops supplying the load voltage VL (load power WL).

The converter 7 has a current limiting function of limiting a current value of a load current supplied from the internal DC bus 4 to the load device L to an upper limit current value. The upper limit current value is set by the power management device 10. The converter 7 has a power measurement function of measuring the load power WL supplied from the internal DC bus 4 to the load device L based on the load voltage VL and the load current. The converter 7 periodically measures the load power WL, for example. The converter 7 transmits the measured value of the load power WL to the power management device 10.

The power storage device 8 is a device for storing surplus electric power that occurs in the power feeding system 21 and supplying deficient electric power that occurs in the power feeding system 21. When the difference power obtained by subtracting the sum of the load power WL from the sum of the supply power is larger than 0, surplus electric power equal to the magnitude (power value) of the difference power occurs. The supply power is electric power supplied to the internal DC bus 4. In the present embodiment, the supply power is the generated power Wre, and the system power Ws. To each power storage device 8, for example, power Wc obtained by equally dividing surplus electric power by the number of power storage devices 8 is supplied from the internal DC bus 4. When the difference power is smaller than 0, deficient electric power equal to the magnitude of the difference power occurs. From each power storage device 8, for example, power Wc obtained by equally dividing the deficient electric power by the number of power storage devices 8 is released to the internal DC bus 4.

The number of power storage devices 8 is not limited to three, and may be appropriately changed as necessary. Each of the power storage devices 8 includes a storage battery 81, a battery management unit (BMU) 82, and a bidirectional DC/DC converter 83 (third converter).

The storage battery 81 is a chargeable and dischargeable device. The storage battery 81 is connected to the internal DC bus 4 via the bidirectional DC/DC converter 83. Examples of the storage battery 81 include a lithium ion battery, a sodium-sulfur (NAS) battery, a redox flow battery, a lead acid battery, and a nickel metal hydride battery. In the present embodiment, the storage batteries 81 included in the power storage devices 8 are of the same type and have the same storage capacity. The storage capacity is the maximum amount of electric power that can be stored. The storage batteries 81 included in the power storage devices 8 may be different types of storage batteries and may have different storage capacities. The storage battery 81 includes, for example, a plurality of battery cells.

The BMU 82 is a device that manages the storage battery 81. The BMU 82 has a function of measuring a battery voltage Vbat of the storage battery 81, and a function of calculating a state of charge (SOC) by measuring the current value of the charging and discharging current of the storage battery 81. The BMU 82 may further have a function of measuring cell voltages of the battery cells constituting the storage battery 81. The BMU 82 transmits the battery information of the storage battery 81 to the power management device 10. The battery information includes, for example, the measured value of the battery voltage Vbat, the current value of the charging and discharging current, the temperature of the storage battery 81, the storage capacity of the battery 81, and the SOC. The BMU 82 periodically transmits the battery information to the power management device 10.

The bidirectional DC/DC converter 83 is connected to the internal DC bus 4, and is a device capable of bidirectionally converting between the internal bus voltage Vbus2 and the battery voltage Vbat. The bidirectional DC/DC converter 83 is provided between the storage battery 81 and the internal DC bus 4. The battery voltage Vbat is the voltage of the storage battery 81. As the bidirectional DC/DC converter 83, a known bidirectional DC/DC converter can be used. The bidirectional DC/DC converter 83 operates with, for example, a DC voltage internally generated based on the internal bus voltage Vbus2.

The bidirectional DC/DC converter 83 is controlled by the power management device 10. Specifically, when the bidirectional DC/DC converter 83 receives a charge command from the power management device 10, the bidirectional DC/DC converter 83 converts the internal bus voltage Vbus2 into the battery voltage Vbat and causes a charging current to flow from the internal DC bus 4 to the storage battery 81. Thus, the storage battery 81 is charged. When the bidirectional DC/DC converter 83 receives a discharge command from the power management device 10, the bidirectional DC/DC converter 83 converts the battery voltage Vbat into the internal bus voltage Vbus2 and causes a discharging current to flow from the storage battery 81 to the internal DC bus 4. Thus, the storage battery 81 is discharged. The bidirectional DC/DC converter 83 may charge or discharge the storage battery 81 in a constant-current manner or in a constant-voltage manner.

When the bidirectional DC/DC converter 83 receives a stop command from the power management device 10, the bidirectional DC/DC converter 83 stops the operation and shifts to a sleep state in which the electric power consumption is reduced. When the bidirectional DC/DC converter 83 receives the charge command or the discharge command in the sleep state, the bidirectional DC/DC converter 83 exits from the sleep state and executes the charge process or the discharge process. The bidirectional DC/DC converter 83 has a current limiting function of limiting each current value of the charging current supplied to the storage battery 81 and the discharging current discharged from the storage battery 81 to a maximum current value or less. The bidirectional DC/DC converter 83 receives a setting command for the maximum current value from the power management device 10, the bidirectional DC/DC converter 83 sets the maximum current values of the charging current and discharging current to the maximum current value specified by the setting command.

When the bidirectional DC/DC converter 83 receives a setting command for a target value of the internal bus voltage Vbus2 from the power management device 10, the bidirectional DC/DC converter 83 sets the target value of the internal bus voltage Vbus2 to the target value specified by the setting command. The target value is a voltage value for making the voltage value of the internal bus voltage Vbus2 constant. The bidirectional DC/DC converter 83 has a function of maintaining the voltage value of the internal bus voltage Vbus2 at the target value even when the power Wc is changed.

The bidirectional DC/DC converter 83 has a power measurement function of measuring the power Wc. The bidirectional DC/DC converter 83 periodically measures the power Wc, for example. The bidirectional DC/DC converter 83 transmits the measured value of the power Wc to the power management device 10.

The bidirectional DC/DC converter 9 is provided between the external DC bus 3 and the internal DC bus 4, and is a device capable of bidirectionally converting between the external bus voltage Vbus1 and the internal bus voltage Vbus2. As the bidirectional DC/DC converter 9, a known bidirectional DC/DC converter can be used. The bidirectional DC/DC converter 9 operates with, for example, a DC voltage internally generated based on the internal bus voltage Vbus2.

The bidirectional DC/DC converter 9 is controlled by the power management device 10. When the bidirectional DC/DC converter 9 receives a setting command for a target value of the external bus voltage Vbus1 from the power management device 10, the bidirectional DC/DC converter 9 sets the target value of the external bus voltage Vbus1 to the target value specified by the setting command. The target value is a voltage value for making the voltage value of the external bus voltage Vbus1 constant.

When the bidirectional DC/DC converter 9 receives a stop command from the power management device 10, the bidirectional DC/DC converter 9 stops the operation and shifts to a sleep state in which the electric power consumption is reduced. When the bidirectional DC/DC converter 9 receives the setting command for the target value of the external bus voltage Vbus1 in the sleep state, the bidirectional DC/DC converter 9 exits from the sleep state and executes the power transmission/reception process.

The bidirectional DC/DC converter 9 has a current measurement function of measuring an electric current input/output between the bidirectional DC/DC converter 9 and the external DC bus 3 or an electric current input/output between the bidirectional DC/DC converter 9 and the internal DC bus 4. The bidirectional DC/DC converter 9 periodically measures the electric current, for example. The bidirectional DC/DC converter 9 transmits the measured value of the electric current to the power management device 10.

The power management device 10 is a device (controller) that manages the entire power feeding system 21. The power management device 10 is also referred to as an energy management system (EMS). The power management device 10 is connected to the power supply device 5, the auxiliary power supply device 6, the converters 7, the power storage devices 8, and the bidirectional DC/DC converter 9 via a communication line so as to be able to communicate with each other. The communication line may be configured to be wired or wireless. The power management device 10 may perform communication conforming to standards such as RS-232C, RS-485, Controller Area Network (CAN), Ethernet (registered trademark), and Wi-Fi (registered trademark).

The power management device 10 performs a voltage measurement process of measuring the internal bus voltage Vbus2. The power management device 10 may directly measure the internal bus voltage Vbus2. The power management device 10 may indirectly measure the internal bus voltage Vbus2 by the bidirectional DC/DC converter 83 measuring the internal bus voltage Vbus2 and transmitting the measured value to the power management device 10.

The power management device 10 transmits a start command and a stop command to each of the power conditioner 52, the AC/DC converter 62, the converters 7, the bidirectional DC/DC converters 83, and the bidirectional DC/DC converter 9. For example, the power management device 10 causes the converter 7 to supply the load voltage VL by transmitting the start command to the converter 7. The power management device 10 causes the converter 7 to stop supplying the load voltage VL by transmitting the stop command to the converter 7. The same applies to the other converters.

The power management device 10 performs a charge and discharge process of charging and discharging the storage battery 81 by controlling the bidirectional DC/DC converter 83. The power management device 10 performs the charge and discharge process depending on the difference power. When the sum of the supply power is larger than the sum of the load power WL (when the difference power is larger than 0), the power management device 10 transmits the charge command to the bidirectional DC/DC converter 83 and causes the storage battery 81 to store surplus electric power that is the difference power. In each storage battery 81, for example, electric power obtained by equally dividing the surplus electric power by the number of storage batteries 81 is stored. When the sum of the supply power is smaller than the sum of the load power WL (when the difference power is smaller than 0), the power management device 10 transmits the discharge command to the bidirectional DC/DC converter 83 and causes the storage battery 81 to discharge the deficient electric power. For example, electric power obtained by equally dividing the deficient electric power by the number of storage batteries 81 is discharged from each storage battery 81.

The power management device 10 switches the operation mode of the power feeding system 21 by controlling the bidirectional DC/DC converter 9. Details will be described later.

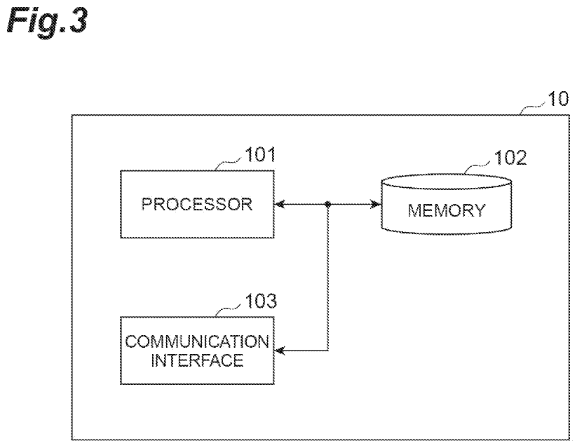

FIG. 3 is a hardware configuration diagram of the power management device shown in FIG. 2. As shown in FIG. 3, the power management device 10 may be physically configured as a computer including hardware such as a processor 101, a memory 102, and a communication interface 103. The power management device 10 may be constituted by a single computer or may be constituted by a plurality of computers as in cloud computing.

An example of the processor 101 is a central processing unit (CPU). The memory 102 may include a main storage device and an auxiliary storage device. The main storage device is constituted by a random access memory (RAM), a read only memory (ROM), and the like. Examples of the auxiliary storage device include a semiconductor memory and a hard disk device. The communication interface 103 is a device that transmits/receives data to/from other devices. The communication interface 103 includes, for example, a communication module, a network interface card (MC), or a wireless communication module conforming to a communication standard such as RS-232C, RS-485, or CAN.

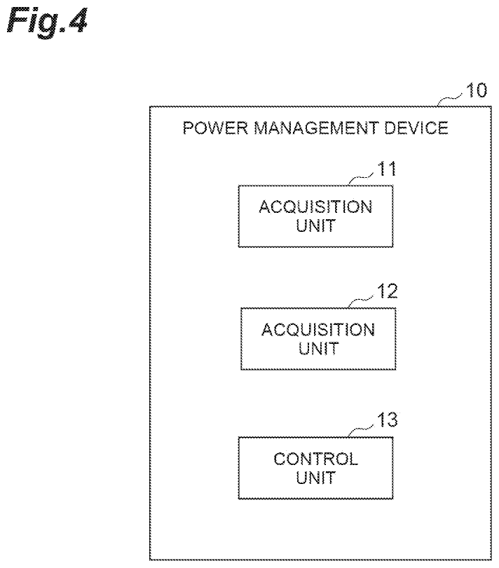

By the processor 101 reading a program stored in the memory 102 to execute the program, each hardware operates under the control of the processor 101 to read and write data from/to the memory 102. Thus, each functional unit of the power management device 10 shown in FIG. 4 is implemented. The power management device 10 of the power feeding system 22 has a hardware configuration similar to that of the power management device 10 of the power feeding system 21.

FIG. 4 is a functional block diagram of the power management device shown in FIG. 2. Here, the functional configuration of the power management device 10 of the power feeding system 21 will be described, but the power management device 10 of the power feeding system 22 has a functional configuration similar to that of the power management device 10 of the power feeding system 21. As shown in FIG. 4, the power management device 10 functionally includes an acquisition unit 11 (first acquisition unit), an acquisition unit 12 (second acquisition unit), and a control unit 13.

The acquisition unit 11 is a functional unit that acquires the amount of electric power stored in the power feeding system 21. The term “the amount of electric power stored in the power feeding system” may be referred to as “the amount of stored electric power of the power feeding system”. The acquisition unit 11 receives the battery information from each BMU 82, and calculates the SOC of the entire power feeding system 21 based on the SOC and the storage capacity included in the battery information. For example, the acquisition unit 11 calculates the amount of electric power stored in each storage battery 81 from the SOC and the storage capacity of each storage battery 81, and calculates the SOC of the entire power feeding system 21 by dividing the total amount of electric power stored in all storage batteries 81 by the sum of the storage capacities of all storage batteries 81. Then, the acquisition unit 11 acquires the SOC of the entire power feeding system 21 as the amount of electric power stored in the power feeding system 21. The acquisition unit 11 may acquire the minimum amount of stored electric power (SOC) among the amounts of stored electric power of all the storage batteries 81 as the amount of electric power stored in the power feeding system 21.

The acquisition unit 12 is a functional unit that acquires a measured value of the external bus voltage Vbus1 supplied to the external DC bus 3. The acquisition unit 12 may acquire the measured value of the external bus voltage Vbus1 by the bidirectional DC/DC converter 9 measuring the external bus voltage Vbus1 and transmitting the measured value to the power management device 10. A voltage sensor for measuring the external bus voltage Vbus1 may be provided on the external DC bus 3. In this case, the acquisition unit 12 may acquire the measured value of the external bus voltage Vbus1 by the voltage sensor transmitting the measured value of the external bus voltage Vbus1 to the power management device 10.

The control unit 13 is a functional unit that switches the operation mode of the power feeding system 21 by controlling the bidirectional DC/DC converter 9. The operation mode of the power feeding system 21 includes a power reception mode, a power transmission mode, and a normal mode. The power reception mode is a mode in which the power feeding system 21 receives DC electric power from another power feeding system (in the present embodiment, the power feeding system 22). The power transmission mode is a mode in which the power feeding system 21 supplies DC electric power to another power feeding system (in the present embodiment, the power feeding system 22). The normal mode is a mode in which the power feeding system 21 does not transmit or receive electric power to or from another power feeding system (the power feeding system 22 in the present embodiment). The control unit 13 controls the bidirectional DC/DC converter 9 using a storage threshold value Bth1 (first storage threshold value), a storage threshold value Bth2 (second storage threshold value), a storage threshold value Bth3 (third storage threshold value), and a storage threshold value Bth4 (fourth storage threshold value).

The storage threshold value Bth1 is a threshold value for determining that the amount of electric power stored in the power feeding system 21 is insufficient and that electric power needs to be received from another power feeding system (the power feeding system 22 in the present embodiment). The storage threshold value Bth1 is represented by, for example, SOC. The storage threshold value Bth1 is set to, for example, 20%. The storage threshold value Bth2 is a threshold value for determining that the amount of electric power stored in the power feeding system 21 is excessive and that electric power can be transmitted to another power feeding system (the power feeding system 22 in the present embodiment). The storage threshold value Bth2 is larger than the storage threshold value Bth1. The storage threshold value Bth2 is represented by, for example, SOC. The storage threshold value Bth2 is set to, for example, 70%.

The storage threshold value Bth3 is a threshold value for determining that the amount of electric power stored in the power feeding system 21 has been sufficient. The storage threshold value Bth3 is larger than the storage threshold value Bth1 and smaller than the storage threshold value Bth2. The storage threshold value Bth3 is represented by, for example, SOC. The storage threshold value Bth3 is set to 50%, for example. The storage threshold value Bth4 is a threshold value for determining that the amount of electric power stored in the power feeding system 21 decreases and no more electric power can be transmitted to another power feeding system (in the present embodiment, the power feeding system 22). The storage threshold value Bth4 is larger than the storage threshold value Bth1 and smaller than the storage threshold value Bth2. The storage threshold value Bth4 may be the same value as or the different value from the storage threshold value Bth3. The storage threshold value Bth4 is represented by, for example, SOC. The storage threshold value Bth4 is set to 50%, for example.

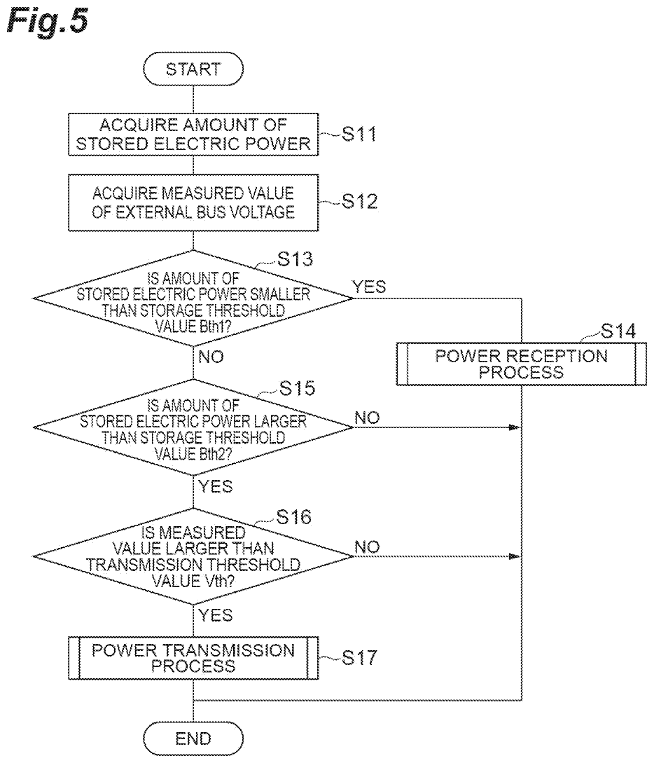

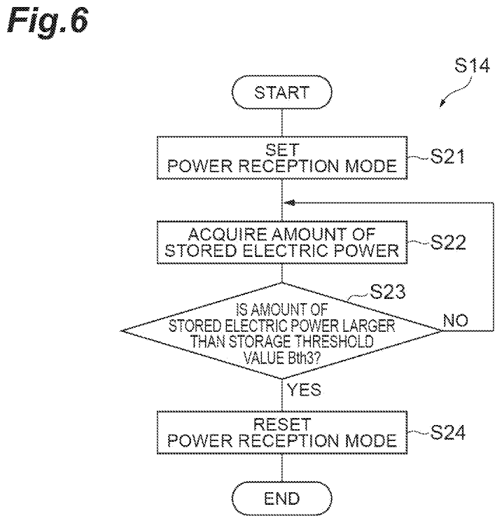

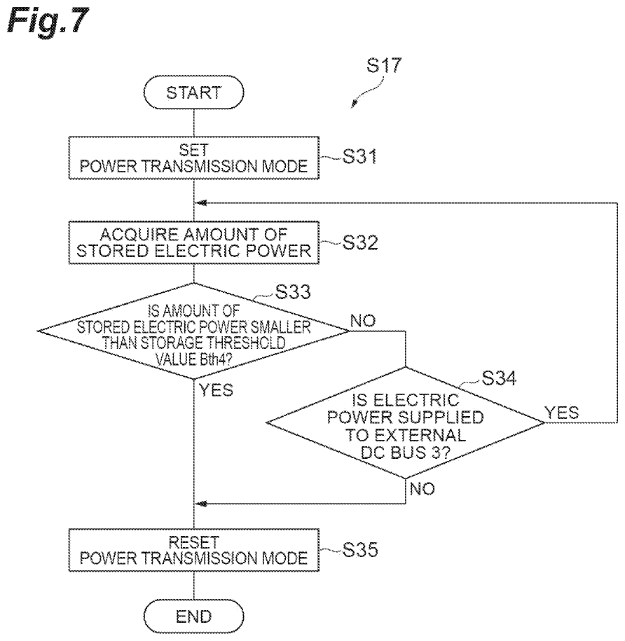

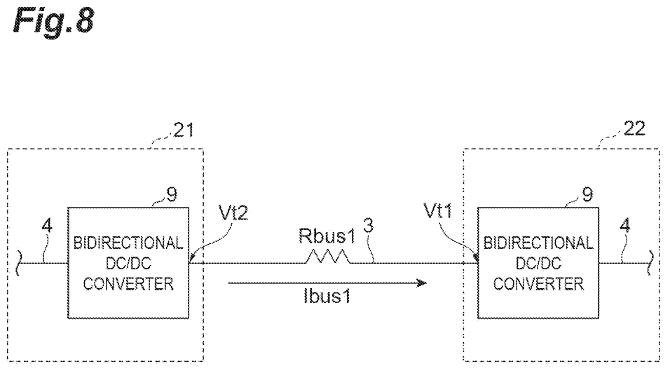

Next, a series of processes of the power management method performed by the power management device 10 will be described with reference to FIGS. 5 to 8. FIG. 5 is a flowchart showing a series of processes of the power management method performed by the power management device shown in FIG. 2. FIG. 6 is a flowchart showing the power reception process shown in FIG. 5 in detail. FIG. 7 is a flowchart showing the power transmission process shown in FIG. 5 in detail. FIG. 8 is a diagram for explaining power transmission and reception between the power feeding systems shown in FIG. 1. The series of processes shown in FIG. 5 is started after a certain period of time has elapsed since the power management device 10 is turned on, and is repeatedly performed while the power management device 10 is operating.

First, the acquisition unit 11 acquires the amount of electric power stored in the power feeding system 21 (step S11). In step S11, the acquisition unit 11 receives the battery information from each BMU 82, for example, and calculates the SOC of the entire power feeding system 21 based on the SOC and the storage capacity included in the battery information. Then, the acquisition unit 11 acquires the SOC of the entire power feeding system 21 as the amount of electric power stored in the power feeding system 21. The acquisition unit 11 may acquire, as the amount of electric power stored in the power feeding system 21, the minimum amount of stored electric power among the amounts of stored electric power of all the batteries 71. Then, the acquisition unit 11 outputs the amount of electric power stored in the power feeding system 21 to the control unit 13.

Subsequently, the acquisition unit 12 acquires a measured value of the external bus voltage Vbus1 (step S12). In step S12, the acquisition unit 12 acquires a measured value of the external bus voltage Vbus1, for example, from the voltage sensor provided on the external DC bus 3 or the bidirectional DC/DC converter 9. Then, the acquisition unit 12 outputs the measured value of the external bus voltage Vbus1 to the control unit 13.

Subsequently, when the control unit 13 receives the amount of electric power stored in the power feeding system 21 from the acquisition unit 11, the control unit 13 determines whether or not the amount of electric power stored in the power feeding system 21 is smaller than the storage threshold value Bth1 by comparing the amount of electric power stored in the power feeding system 21 with the storage threshold value Bth1 (step S13). When it is determined in step S13 that the amount of electric power stored in the power feeding system 21 is smaller than the storage threshold value Bth1 (is less than the storage threshold value Bth1) (step S13; YES), the amount of electric power stored in the power feeding system 21 is insufficient and electric power needs to be received from the power feeding system 22. Therefore, the control unit 13 performs a power reception process (step S14).

In the power reception process in step S14, as shown in FIG. 6, first, the control unit 13 sets the power feeding system 21 (the operation mode of the power feeding system 21) to the power reception mode (step S21). In step S21, the control unit 13 sets the power feeding system 21 to the power reception mode by setting the target value of the external bus voltage Vbus1 in the bidirectional DC/DC converter 9 to a target value Vt1 (first target value). The target value Vt1 is set to, for example, DC 300 V.

Subsequently, in the same manner as in step S11, the acquisition unit 11 acquires the amount of electric power stored in the power feeding system 21 (step S22) and outputs the amount of electric power stored in the power feeding system 21 to the control unit 13. When the control unit 13 receives the amount of electric power stored in the power feeding system 21 from the acquisition unit 11, the control unit 13 determines whether or not the amount of electric power stored in the power feeding system 21 is larger than the storage threshold value Bth3 by comparing the amount of electric power stored in the power feeding system 21 with the storage threshold value Bth3 (step S23). When it is determined in step S23 that the amount of electric power stored in the power feeding system 21 is equal to or smaller than the storage threshold value Bth3 (step S23; NO), the amount of electric power stored in the power feeding system 21 is not sufficient, so that the power reception mode is maintained. Steps S22 and S23 are repeated until the amount of electric power stored in the power feeding system 21 becomes larger than the storage threshold value Bth3 by receiving electric power from the power feeding system 22.

On the other hand, when it is determined in step S23 that the amount of electric power stored in the power feeding system 21 is larger than the storage threshold value Bth3 (exceeds the storage threshold value Bth3) (step S23; YES), the control unit 13 resets the power reception mode of the power feeding system 21 (step S24). For example, the control unit 13 resets the power reception mode of the power feeding system 21 by stopping the bidirectional DC/DC converter 9, and sets the power feeding system 21 to the normal mode. At this time, the bidirectional DC/DC converter 9 stops converting the external bus voltage Vbus1 to the internal bus voltage Vbus2, and stops passing an electric current from the external DC bus 3 to the internal DC bus 4.

Thus, the power reception process in step S14 is completed, and the series of processes shown in FIG. 5 is completed.

On the other hand, when it is determined in step S13 that the amount of electric power stored in the power feeding system 21 is equal to or larger than the storage threshold value Bth1 (step S13; NO), the control unit 13 determines whether or not the amount of electric power stored in the power feeding system 21 is larger than the storage threshold value Bth2 by comparing the amount of electric power stored in the power feeding system 21 with the storage threshold value Bth2 (step S15). When it is determined in step S15 that the amount of electric power stored in the power feeding system 21 is equal to or smaller than the storage threshold value Bth2 (step S15; NO), the amount of electric power stored in the power feeding system 21 is not insufficient but is not surplus. In this case, the power feeding system 21 maintains the normal mode in which electric power is not supplied to or received from the power feeding system 22, and the series of processes shown in FIG. 5 is completed.

On the other hand, when it is determined in step S15 that the amount of electric power stored in the power feeding system 21 is larger than the storage threshold value Bth2 (exceeds the storage threshold value Bth2) (step S15; YES), the amount of electric power stored in the power feeding system 21 is excessive, so that the power feeding system 21 is in a state in which electric power can be transmitted to the power feeding system 22. In this case, the control unit 13 determines whether or not the measured value of the external bus voltage Vbus1 is larger than the transmission threshold value Vth (step S16). The transmission threshold value Vth is a threshold value for determining that another power feeding system (power feeding system 22 in the present embodiment) is in the power reception mode. That is, step S16 is a step in which the power feeding system 21, which is a power source, determines whether or not there is any power feeding system that needs to receive electric power (in this case, whether or not the power feeding system 22 is set to the power reception mode).

When none of the power feeding systems is set to the power reception mode, no voltage is supplied to the external DC bus 3, so that the external bus voltage Vbus1 is OV. On the other hand, as described above, when the power feeding system 22 is set to the power reception mode, the target value of the external bus voltage Vbus1 in the bidirectional DC/DC converter 9 of the power feeding system 22 is set to the target value Vt1. In other words, the transmission threshold value Vth is also a threshold value for determining that the target value of the external bus voltage Vbus1 is set to the target value Vt1 by another power feeding system (power feeding system 22 in the present embodiment). Since a voltage drop may occur due to the resistance component of the external DC bus 3, the measured value measured by the bidirectional DC/DC converter 9 of the power feeding system 21 or the voltage sensor may be smaller than the target value Vt1. Therefore, the transmission threshold value Vth is set to a value obtained by subtracting a voltage value larger than the voltage drop due to the resistance component of the external DC bus 3 from the target value Vt1. The transmission threshold value Vth is set to, for example, DC 240 V.

When it is determined in step S16 that the measured value of the external bus voltage Vbus1 is equal to or smaller than the transmission threshold value Vth (step S16; NO), there is no power feeding system that needs to receive electric power, so that the power feeding system 21 does not perform the power transmission. Therefore, the power feeding system 21 maintains the normal mode and the series of processes shown in FIG. 5 is completed.

On the other hand, when it is determined in step S16 that the measured value of the external bus voltage Vbus1 is larger than the transmission threshold value Vth (exceeds the transmission threshold value Vth) (step S16; YES), the control unit 13 performs a power transmission process (step S17).

In the power transmission process in step S17, as shown in FIG. 7, first, the control unit 13 sets the power feeding system 21 (the operation mode of the power feeding system 21) to the power transmission mode (step S31). In step S31, the control unit 13 sets the power feeding system 21 to the power transmission mode by setting the target value of the external bus voltage Vbus1 in the bidirectional DC/DC converter 9 to a target value Vt2 (second target value). The target value Vt2 is larger than the target value Vt1. For example, the target value Vt2 is set to DC 380 V.

Subsequently, in the same manner as in step S11, the acquisition unit 11 acquires the amount of electric power stored in the power feeding system 21 (step S32) and outputs the amount of electric power stored in the power feeding system 21 to the control unit 13. When the control unit 13 receives the amount of electric power stored in the power feeding system 21 from the acquisition unit 11, the control unit 13 determines whether or not the amount of electric power stored in the power feeding system 21 is smaller than the storage threshold value Bth4 by comparing the amount of electric power stored in the power feeding system 21 with the storage threshold value Bth4 (step S33).

When it is determined in step S33 that the amount of electric power stored in the power feeding system 21 is equal to or larger than the storage threshold value Bth4 (step S33; NO), a sufficient amount of stored electric power remains in the power feeding system 21 to be supplied to the power feeding system 22. In this case, the control unit 13 determines whether or not electric power is supplied to the external DC bus 3 via the bidirectional DC/DC converter 9 (step S34). When the power feeding system 22 resets the power reception mode, no electric power is supplied from the power feeding system 21 to the external DC bus 3. That is, step S34 is a step for determining whether or not the power feeding system 22 has reset the power reception mode.

In step S34, for example, the control unit 13 determines whether or not electric power is supplied to the external DC bus 3 by comparing the current value of the electric current output from the bidirectional DC/DC converter 9 to the external DC bus 3 or the current value of the electric current input from the internal DC bus 4 to the bidirectional DC/DC converter 9 with a current threshold value Ith. The control unit 13 determines that no electric power is supplied to the external DC bus 3 when the current value is smaller than the current threshold value Ith, and determines that electric power is supplied to the external DC bus 3 when the current value is equal to or larger than the current threshold value Ith. As described above, the bidirectional DC/DC converter 9 measures the current value and transmits the measured value of the electric current to the power management device 10, whereby the control unit 13 acquires the current value. The control unit 13 may determine whether or not electric power is supplied to the external DC bus 3 by comparing the measured value of electric power output from the bidirectional DC/DC converter 9 to the external DC bus 3 or the measured value of electric power input from the internal DC bus 4 to the bidirectional DC/DC converter 9 with a threshold value.

When it is determined in step S34 that electric power is supplied to the external DC bus 3 (step S34; YES), the power feeding system 22 maintains the power reception mode, so that the power feeding system 21 maintains the power transmission mode. Steps S32 to S34 are repeated until the amount of electric power stored in the power feeding system 21 becomes smaller than the storage threshold value Bth4 by transmitting electric power to the power feeding system 22, or until supplying electric power to the external DC bus 3 is stopped by the power feeding system 22 resetting the power reception mode.

When it is determined in step S33 that the amount of electric power stored in the power feeding system 21 is smaller than the storage threshold value Bth4 (is less than the storage threshold value Bth4) (step S33; YES) or when it is determined in step S34 that no electric power is supplied from the power feeding system 21 to the external DC bus 3 (step S34; NO), the control unit 13 resets the power transmission mode of the power feeding system 21 (step S35). For example, the control unit 13 resets the power transmission mode of the power feeding system 21 by stopping the bidirectional DC/DC converter 9, and sets the power feeding system 21 to the normal mode. As a result, the bidirectional DC/DC converter 9 stops converting the internal bus voltage Vbus2 into the external bus voltage Vbus1, and stops passing an electric current from the internal DC bus 4 to the external DC bus 3.

Thus, the power transmission process in step S17 is completed, and the series of processes shown in FIG. 5 is completed.

Step S12 may be performed prior to step S11, or may be performed in parallel with step S11. Step S12 may be performed at regular intervals. Steps S15 and S16 may be performed prior to step S13, or may be performed in parallel with step S13. Step S16 may be performed prior to step S15, or may be performed in parallel with step S15. Step S34 may be performed prior to step S33, or may be performed in parallel with step S33.

When a certain value is compared with a threshold value in each determination, if the value is equal to the threshold value, any determination result may be applied. For example, in step S13, the control unit 13 determines whether or not the amount of stored electric power is smaller than the storage threshold value Bth1, but may determine whether or not the amount of stored electric power is equal to or smaller than the storage threshold value Bth1. The same applies to other determinations.

An example of power transmission/reception between the power feeding system 21 and the power feeding system 22 will now be described with reference to FIG. 8. FIG. 8 shows a case where electric power is transmitted from the power feeding system 21 to the power feeding system 22. Here, the target value of the external bus voltage Vbus1 in the bidirectional DC/DC converter 9 of the power feeding system 21 is set to the target value Vt2, and the target value of the external bus voltage Vbus1 in the bidirectional DC/DC converter 9 of the power feeding system 22 is set to the target value Vt1. As a result, a voltage having a voltage value of the target value Vt2 is supplied to one end of the external DC bus 3 (a connection point between the power feeding system 21 and the external DC bus 3), and a voltage having a voltage value of the target value Vt1 is supplied to the other end of the external DC bus 3 (a connection point between the power feeding system 22 and the external DC bus 3). Since the target value Vt2 is larger than the target value Vt1, a potential difference (the target value Vt2−the target value Vt1) is generated on the external DC bus 3. As a result, an external bus current Ibus 1 flows on the external DC bus 3 from the power feeding system 21 toward the power feeding system 22. Thus, external electric power having power value obtained by multiplying the current value of the external bus current Ibusl by the target value Vt1 is supplied to the power feeding system 22. The external bus current Ibus 1 is detected, for example, by a current sensor (such as a Hall element current sensor, a flux gate current sensor, or a magnet resistive current sensor) provided at an output portion of the bidirectional DC/DC converter 9 or at a connection point between the bidirectional DC/DC converter 9 and the external DC bus 3 (the connection point between the power feeding system 21 and the external DC bus 3).

In the power management device 10, the power feeding system 21, and the power management method described above, the operation mode of the power feeding system 21 is switched based on the amount of electric power stored in the power feeding system 21. For example, when the amount of electric power stored in the power feeding system 21 is less than the storage threshold value Bth1, the target value of the external bus voltage Vbus1 in the bidirectional DC/DC converter 9 of the power feeding system 21 is set to the target value Vt1, and the power feeding system 21 is set to the power reception mode. At this time, on the assumption that the power feeding system 22 is set to the power transmission mode, the target value of the external bus voltage Vbus1 in the bidirectional DC/DC converter 9 of the power feeding system 22 is set to the target value Vt2. Since the target value Vt2 is larger than the target value Vt1, a potential difference is generated in the external DC bus 3, and electric power is supplied from the power feeding system 22 set to the power transmission mode toward the power feeding system 21 set to the power reception mode.

Similarly, on the assumption that the power feeding system 22 is set to the power reception mode, the target value of the external bus voltage Vbus1 in the bidirectional DC/DC converter 9 of the power feeding system 22 is set to the target value Vt1. Therefore, since the measured value of the external bus voltage Vbus1 exceeds the transmission threshold value Vth, when the amount of electric power stored in the power feeding system 21 exceeds the storage threshold value Bth2, the target value of the external bus voltage Vbus1 in the bidirectional DC/DC converter 9 of the power feeding system 21 is set to the target value Vt2, and the power feeding system 21 is set to the power transmission mode. Also, in this case, a potential difference is generated in the external DC bus 3, and electric power is supplied from the power feeding system 21 set to the power transmission mode toward the power feeding system 22 set to the power reception mode. According to this configuration, it is not necessary for the power feeding system 21 to transmit a power reception request or the like via the communication network. Therefore, electric power can be transmitted and received without using any communication network.

As described above, the control unit 13 resets the power reception mode of the power feeding system 21 in response to the amount of electric power stored in the power feeding system 21 exceeding the storage threshold value Bth3 in a state in which the power feeding system 21 is set to the power reception mode. According to this configuration, the power reception mode can be reset before the power feeding system 21 receives excessive electric power. This makes it possible to receive electric power from the power feeding system 22 to the extent that the power feeding system 21 does not receive electric power more than necessary.

As described above, the control unit 13 resets the power transmission mode of the power feeding system 21 in response to the amount of electric power stored in the power feeding system 21 becoming less than the storage threshold value Bth4 in a state in which the power feeding system 21 is set to the power transmission mode. According to this configuration, the power transmission mode can be reset before the amount of electric power stored in the power feeding system 21 becomes insufficient. This makes it possible to transmit electric power to the power feeding system 22 to the extent that the amount of electric power stored in the power feeding system 21 is not insufficient.

As described above, the control unit 13 resets the power transmission mode of the power feeding system 21 in response to detecting that no electric power is supplied to the external DC bus 3 via the bidirectional DC/DC converter 9 in a state in which the power feeding system 21 is set to the power transmission mode. When no electric power is supplied to the external DC bus 3 via the bidirectional DC/DC converter 9, it is considered that the power feeding system 22 has reset the power reception mode. In this case, it is not necessary for the power feeding system 21 to transmit electric power to the power feeding system 22. According to the configuration described above, when the power feeding system 22 resets the power reception mode, the power feeding system 21 can reset the power transmission mode.

It should be noted that the power management device, the power feeding system, and the power management method according to the present disclosure are not limited to the above-described embodiments.

At least one of the power conditioner 52, the AC/DC converter 62, the converter 7, the bidirectional DC/DC converter 83, and the bidirectional DC/DC converter 9 may not have the power measurement function. In this case, the power management device 10 may acquire the measured value of each electric power from the measured value of the voltage measured by the voltage sensor and the measured value of the electric current measured by the current sensor.

The power supply device 5 may include another power generation device in place of the renewable energy power generation device 51.

The auxiliary power supply device 6 may include a power generation device in place of the commercial power supply 61. An example of the power generation device is a diesel generator. In this case, the number of the auxiliary power supply devices 6 is not limited to one, and may be appropriately changed as necessary. When the auxiliary power supply device 6 does not include the commercial power supply 61, the power feeding systems 21 and 22 are also referred to as independent DC power feeding systems. The auxiliary power supply device 6 may be used only when the power feeding systems 21 and 22 are started up. For example, when an electric power shortage occurs in the power feeding system 21, the power feeding system 21 may first receive electric power from the power feeding system 22, and then may receive electric power from the auxiliary power supply device 6 when electric power cannot be received from the power feeding system 22.

In the above-described embodiment, each of the power conditioner 52, the AC/DC converter 62, the converters 7, the bidirectional DC/DC converters 83, and the bidirectional DC/DC converter 9 operates with a DC voltage generated inside the device. Alternatively, each of the power feeding systems 21 and 22 may include a power supply unit, which generates a DC voltage having a constant voltage value from the internal bus voltage Vbus2 of the internal DC bus 4, and supplies the DC voltage (electric power) to each device.

The power feeding system 21 may not include the renewable energy power generation device 51. In this case, the renewable energy power generation device 51 provided outside the power feeding system 21 may be connected to the internal DC bus 4 via the power conditioner 52 included in the power feeding system 21.

The power feeding system 21 may not include the commercial power supply 61. In this case, the commercial power supply 61 provided outside the power feeding system 21 may be connected to the internal DC bus 4 via the AC/DC converter 62 included in the power feeding system 21.

The control unit 13 may determine whether or not electric power is supplied to the external DC bus 3 using the measured value of the external bus voltage Vbus1. When the power feeding system 22 resets the power reception mode, the target value of the external bus voltage Vbus1 in the bidirectional DC/DC converter 9 of the power feeding system 22 is set to 0. However, since the power feeding system 21 is set to the power transmission mode, the target value of the external bus voltage Vbus1 in the bidirectional DC/DC converter 9 is set to the target value Vt2. Therefore, even if the external bus voltage Vbus1 is simply measured, it cannot be determined whether or not the power feeding system 22 has reset the power reception mode.

In order to solve this problem, for example, a voltage sensor for measuring the external bus voltage Vbus1 may be provided on the external DC bus 3, and a relay capable of cutting off the external DC bus 3 may be provided between the voltage sensor and the bidirectional DC/DC converter 9. In this configuration, the voltage sensor can measure the external bus voltage Vbus1 without being affected by the target value of the external bus voltage Vbus1 in the bidirectional DC/DC converter 9 of the power feeding system 21 when the relay is in the OFF state (cutoff state).

In the above embodiment, the power interchange system 1 includes two power feeding systems, but may include three or more power feeding systems. In this configuration, one or more power feeding systems can be set to the power transmission mode and one or more power feeding systems can be set to the power reception mode. Also, in this case, electric power is transmitted and received between the power feeding system(s) set to the power transmission mode and the power feeding system(s) set to the power reception mode at the same time. For example, when two power feeding systems are set to the power reception mode, the target value Vt1 is set on the external DC bus 3 by these two power feeding systems. At this time, if the amount of electric power stored in each of two other power feeding systems is larger than the storage threshold value Bth2, these two power feeding systems are set to the power transmission mode, and electric power is transmitted toward the two power feeding systems set to the power reception mode.

When electric power is transmitted and received between several power feeding systems, if the amount of electric power stored in another power feeding system becomes smaller than the storage threshold value Bth1, the target value of the external bus voltage Vbus1 in the bidirectional DC/DC converter 9 of the power feeding system is set to the target value Vt1. As a result, the power feeding system is set to the power reception mode, and the power feeding system can receive electric power from the power feeding system(s) set to the power transmission mode. Similarly, when electric power is transmitted and received between several power feeding systems, the measured value of the external bus voltage Vbus1 is larger than the transmission threshold Vth. In this state, when the amount of stored electric power of another power feeding system becomes larger than the storage threshold value Bth2, the target value of the external bus voltage Vbus1 in the bidirectional DC/DC converter 9 of the power feeding system is set to the target value Vt2. As a result, the power feeding system is set to the power transmission mode, and the power feeding system can supply electric power to the power feeding system set to the power reception mode.

What is claimed is:

1. A power management device comprising:
a first acquisition unit configured to acquire an amount of stored electric power of a power feeding system connected to another power feeding system via an external direct current (DC) bus;
a second acquisition unit configured to acquire a measured value of an external bus voltage supplied to the external DC bus; and
a control unit configured to switch an operation mode of the power feeding system by controlling a converter provided between the external DC bus and an internal DC bus for supplying DC electric power in the power feeding system, the converter being capable of bidirectionally converting between the external bus voltage and an internal bus voltage supplied to the internal DC bus,
wherein the control unit sets the power feeding system to a power reception mode by setting a target value of the external bus voltage in the converter to a first target value when the amount of stored electric power is less than a first storage threshold value, and
wherein the control unit sets the power feeding system to a power transmission mode by setting the target value to a second target value that is larger than the first target value when the amount of stored electric power exceeds a second storage threshold value that is larger than the first storage threshold value and the measured value exceeds a transmission threshold value.

2. The power management device according to claim 1,
wherein the control unit resets the power reception mode in response to the amount of stored electric power exceeding a third storage threshold value that is smaller than the second storage threshold value and larger than the first storage threshold value when the power feeding system is set to the power reception mode.

3. The power management device according to claim 1,
wherein the control unit resets the power transmission mode in response to the amount of stored electric power becoming less than a fourth storage threshold value that is smaller than the second storage threshold value and larger than the first storage threshold value when the power feeding system is set to the power transmission mode.

4. The power management device according to claim 1,
wherein the control unit resets the power transmission mode in response to detecting that no electric power is supplied to the external DC bus via the converter when the power feeding system is set to the power transmission mode.

5. A power feeding system for supplying electric power bidirectionally with respect to another power feeding system via an external direct current (DC) bus, the power feeding system comprising:
an internal DC bus for supplying DC electric power;
a first converter provided between a power supply device and the internal DC bus, the first converter being configured to convert a voltage generated by the power supply device into an internal bus voltage supplied to the internal DC bus;
a second converter connected to the internal DC bus, the second converter being configured to convert the internal bus voltage into a load voltage supplied to a load device;
a storage battery;
a third converter provided between the storage battery and the internal DC bus, the third converter being capable of bidirectionally converting between the internal bus voltage and a battery voltage of the storage battery;
a fourth converter provided between the internal DC bus and the external DC bus, the fourth converter being capable of bidirectionally converting between the internal bus voltage and an external bus voltage supplied to the external DC bus; and
a power management device configured to charge and discharge the storage battery by controlling the third converter, and the power management device being configured to switch an operation mode of the power feeding system by controlling the fourth converter,
wherein the power management device sets the power feeding system to a power reception mode by setting a target value of the external bus voltage in the fourth converter to a first target value when an amount of stored electric power of the storage battery is less than a first storage threshold value, and
wherein the power management device sets the power feeding system to a power transmission mode by setting the target value to a second target value that is larger than the first target value when the amount of stored electric power exceeds a second storage threshold value that is larger than the first storage threshold value and a measured value of the external bus voltage exceeds a transmission threshold value.

6. A power management method comprising:
acquiring an amount of stored electric power of a power feeding system connected to another power feeding system via an external direct current (DC) bus;
acquiring a measured value of an external bus voltage supplied to the external DC bus;
setting the power feeding system to a power reception mode by setting a target value of the external bus voltage in a converter provided between the external DC bus and an internal DC bus for supplying DC electric power in the power feeding system to a first target value when the amount of stored electric power is less than a first storage threshold value, the converter being capable of bidirectionally converting between the external bus voltage and an internal bus voltage supplied to the internal DC bus; and
setting the power feeding system to a power transmission mode by setting the target value to a second target value that is larger than the first target value when the amount of stored electric power exceeds a second storage threshold value that is larger than the first storage threshold value and the measured value exceeds a transmission threshold value.
